(19) United States
(12) Patent Application Publication
(10) Pub. No.: US 2024/0368739 A1
(43) Pub. Date: Nov. 7, 2024

(54) METHOD OF MANUFACTURING AN ALUMINUM ALLOY

(71) Applicant: Southwire Company, LLC, Carrollton, GA (US)

(72) Inventors: Victor Frederic RUNDQUIST, Carrollton, GA (US); Ryan Michael LANDRY, Carrollton, GA (US)

(21) Appl. No.: 18/654,664

(22) Filed: May 3, 2024

Related U.S. Application Data
(60) Provisional application No. 63/500,481, filed on May 5, 2023.
(60) Provisional application No. 63/583,079, filed on Sep. 15, 2023.

(51) Int. Cl. C22C 21/06; C22C 1/02; C22F 1/047; H01B 7/22

(52) U.S. Cl. CPC C22C 21/06; C22C 1/026; C22F 1/047; H01B 7/226

(57) ABSTRACT

An aluminum alloy material is provided. The aluminum allow material includes an alloy composition having by mass %, magnesium in an amount of 1.8%-2.5%, iron in an amount of 0.10%-0.90%, and aluminum in an amount of 98.1%-95% with inevitable impurities. An armored cable with armor being made of the aluminum alloy material is provided.

### CROSS-REFERENCE TO RELATED APPLICATIONS

Under provisions of 35 U.S.C. § 119 (e), Applicant claims the benefit of U.S. Provisional Application No. 63/500,481, filed May 5, 2023 and U.S. Provisional Application No. 63/583,079, filed Sep. 15, 2023, which are incorporated herein by reference.

### BACKGROUND

Cable armor is a metal layer wrapped around the exterior of a cable to provide mechanical protection. Cable armor is used in environments that require an extra layer of cable defense or in situations where Type Metal Clad (MC) is required by the national Electric Code. Cable armor protects the cable against falling objects, crushing or other physical damage. In addition, it adds extra fire resistance, and is safer for electrical maintenance workers.

Common cable armor materials include interlocked galvanized steel, interlocked aluminum, and corrugated and welded aluminum. Steel cable armor has a better crush-resistance, a better impact resistance, and is stronger than aluminum cable armor. But the steel cable armor is 10 to 40 percent heavier than the aluminum cable armor.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an example metal clad armored electrical cable.

FIG. 2 is a diagram illustrating a section view of an armored sheath of a metal clad armored electrical cable.

FIG. 3 is a flow diagram illustrating an example method for making an aluminum alloy for armored cables.

FIG. 4 is a graph illustrating tensile, elongation and yield of the aluminum alloy.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Aspects of the disclosure provide an aluminum alloy (also referred to as UK alloy) for cable armor. The disclosed UK alloy includes by mass 1.8%-2.5% of Magnesium (Mg) with the balance being aluminum and inevitable impurities. Such UK alloy may include by mass 98.2%-95% aluminum of aluminum. In some implementations, the UK alloy includes by mass 1.8%-2.5% of Magnesium (Mg), 0.10%-0.90% of Iron (Fe), and 98.1%-95% aluminum of aluminum. The disclosed UK alloy may be used to manufacture armored cables.

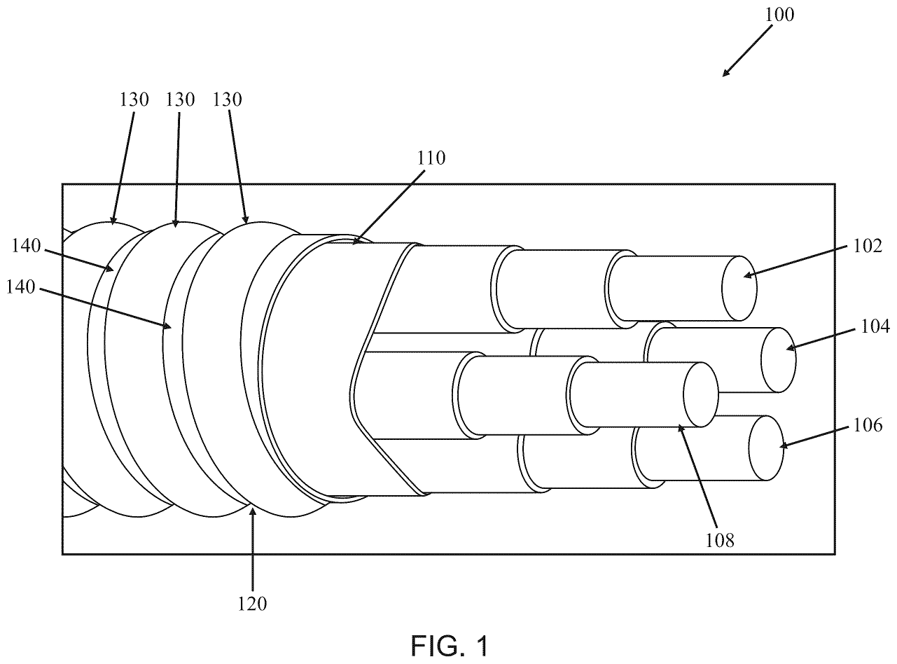

FIG. 1 illustrates a section of metal clad armored electrical cable 100. As shown in FIG. 1, armored electrical cable 100 includes a plurality of conductors, for example, a first conductor 102, a second conductor 104, a third conductor 106, and a fourth conductor 108. Each of first conductor 102, second conductor 104, third conductor 106, and fourth conductor 108 are flexible and may include an insulation layer surrounding a conductor core. In some examples, each of first conductor 102, second conductor 104, third conductor 106, and fourth conductor 108 may include an insulation layer surrounding a stranded conductor core comprising multiple conductor strands. Although first conductor 102, second conductor 104, third conductor 106, and fourth conductor 108 are shown, it should be understood that armored electrical cable 100 may include any number of such conductors. In addition, it should be understood that there may be multiple ground conductors, and/or multiple non-ground conductors, and/or neutral conductors. In some applications, the ground conductors, and/or the non-ground conductors, and/or the neutral conductors may be oversized, that is, be larger in diameter or gauge than at least one other conductor of armored electrical cable 100.

In some implementations, armored electrical cable 100 may include a binder or tape separator 110 wrapped around the plurality of conductors. Binder 110 may separate the plurality of conductors from an armored sheath 120. In some other implementations, binder 110 is wrapped around the plurality of conductors and a bare grounding conductor (not illustrated) is disposed outside of binder 110 and in contact with an inner surface of armored sheath 120 to thereby form a low impedance ground path with armored sheath 120. For example, in one implementation, a binder is wrapped around insulated conductors and the bare grounding conductor is cabled externally to the binder and conductor assembly.

Armored electrical cable 100 further includes armored sheath 120 wrapped around first conductor 102, second conductor 104, third conductor 106, and fourth conductor 108. In some examples, armored sheath 120 may be in contact with binder 110. In one implementation, armored sheath 120 is a continuous strip of metal cladding formed in helical interlocking convolutions thereby providing spaced apart peaks or crowns 130 and valleys 140 disposed between adjacent crowns 130. Crowns 130 and valleys 140 may actually be continuous helical convolutions formed by the strip wrapping process. Each convolutions winds over the previous convolution at a continuous overlap.

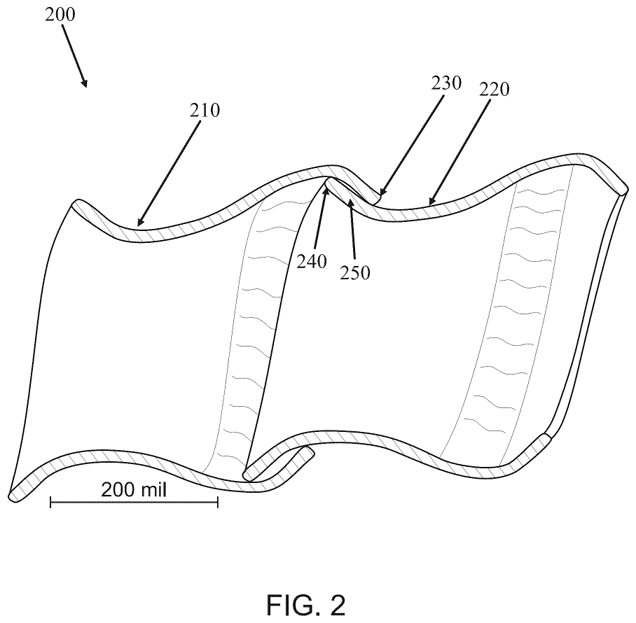

FIG. 2 illustrates a section view 200 of armored sheath 120. As shown in FIG. 2, armored sheath 120 includes a first convolution 210 and a second convolution 220. First and second convolutions 210, 220 may be formed by a strip wrapping process from a single strip, each convolution winding over the previous convolution at a continuous overlap. For example, and as shown in FIG. 2, a leading edge 230 of first convolution 210 overlaps a trailing edge 240 of an adjacent convolution (that is, a second convolution 220) and provides a contact area 250 between leading edge 230 and trailing edge 240 of successive convolutions.

In example implementations, armored sheath 120 is made from the UK alloy. More specifically, armored sheath 120 is made from the UK alloy comprising by mass 1.8%-2.5% of Magnesium (Mg) with the balance being aluminum and inevitable impurities. In some implementations, armored sheath 120 is made from the UK alloy comprising by mass 1.8%-2.5% of Magnesium (Mg) and 0.10%-0.90% of Iron (Fe), with the balance being aluminum and inevitable impurities.

Common thicknesses of armored sheath 120 can be in a range from 3 mil to 50 mil (e.g., 16 mil, 18 mil, 22 mil, etc.). Generally, the cross-sectional width of the metal strip or ribbon may be any that allow an efficient construction (e.g., by limiting the number of convolutions required for a given length) while maintaining an adequate crush resistance. In certain aspects, the ribbon can have a cross-sectional width in a range from 3 mm to 50 mm, from 5 mm to 20 mm, or from 8 to 12 mm.

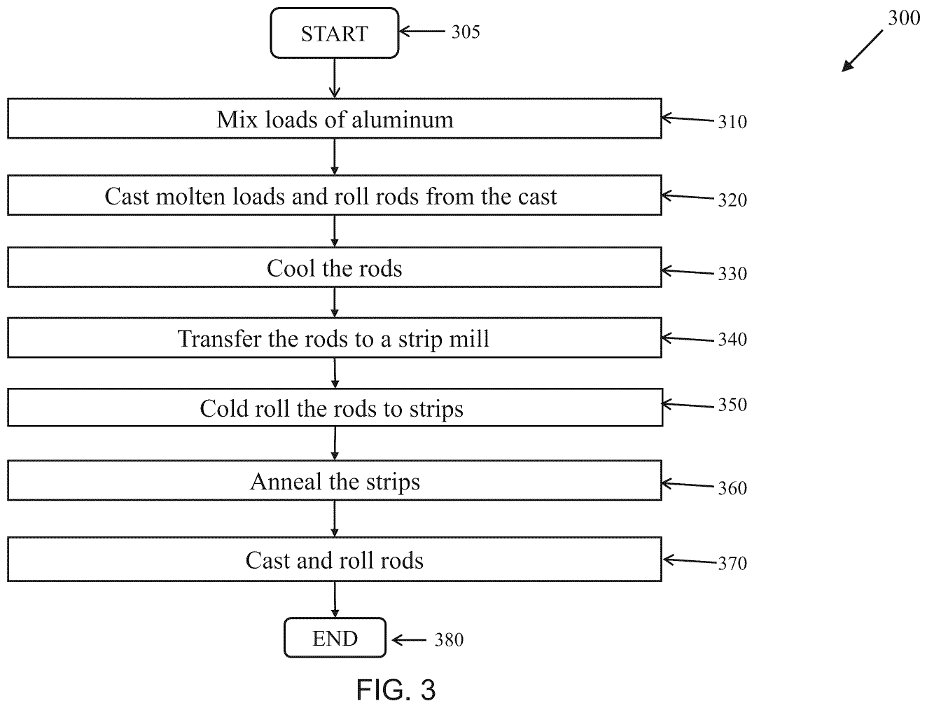

FIG. 3 is a diagram illustrating steps of a method 300 for making the UK alloy. Method 300 may begin at starting block 305 and proceed to stage 310 where loads of aluminum are mixed. The loads of aluminum may include scrap aluminum recycled from aluminum products, for examples, cans, wires, etc. The scrap aluminum may include impurities therein. In some examples, the loads of aluminum may include aluminum sheets with negligible impurities. In some other examples, the loads of aluminum may include the aluminum sheets with negligible impurities and the scrap aluminum recycled from aluminum products, for examples, cans, wires, etc.

The loads of aluminum are heated to a melting point. For example, the loads of aluminum may be heated up to 1400F-150OF where F is degrees Fahrenheit. Once the loads are melted and mixed, percentages of Iron (Fe) and Magnesium (Mg) are determined. For example, it may be determined whether the molten loads include by mass 1.8%-2.5% of Magnesium (Mg) and 0.10%-0.90% of Iron (Fe). If not, then more materials may be added to the loads. For example, more Iron (Fe) or Magnesium (Mg) may be added to increase their percentages. In another example, more aluminum may be added to decrease percentages of Iron (Fe) and Magnesium (Mg).

After mixing the loads of aluminum at stage 310, method 300 proceeds to stage 320 where the loads are cast and rods are rolled from the cast. For example, once the molten loads of aluminum include by mass 1.8%-2.5% of Magnesium (Mg) and 0.10%-0.90% of Iron (Fe), the molten loads are cast, and rods are rolled from the cast. In examples, a diameter of the rods rolled from the cast may be in a range of 0.355″-0.395″.

Once having cast and rods rolled from the cast at stage 320, method 300 proceeds to stage 330 where the rods then are cooled to a room temperature. In one implementation, the rods may be cooled to the room temperature naturally. In other implementations, the rods may be cooled to the room temperature naturally using a cooling aid, for example, a heat sink or a heat ventilator.

After the rods are cooled to the room temperature at stage 330, method 300 proceeds to stage 340 where the rods are transferred to a strip mill. For example, the rods once cooled to the room temperature are transferred to the strip mill. Once being transferred to the strip mill at stage 340, method 300 proceeds to stage 350 where rods are cold rolled to strips. In examples, dimensions of the strip may be 0.375″×0.015″ to 0.750″×0.025″.

After cold rolling the rods to strips at stage 350, method 300 proceeds to stage 360 where the strips are annealed. Annealing may include heating the strips to temperatures between 400 F and 500 F for a predetermined time or annealing time (for example, around 10 hours) and allowing the strips to cool slowly. The annealing time may depend on an amount or a weight of the strips and a size of an annealing container. In addition, the annealing time may also vary based on a heating capacity of the annealing container. For example, if the annealing container can heat the strips to temperatures between 400 F and 500 F in a shorter time frame than 10 hours, then the annealing time is reduced. Once the strips are annealed at stage 360, method 300 proceeds to stage 370 where the rods are cast and rolled. After the rods are cast and rolled at stage 370, method 300 terminates at end block 380.

Thus, the UK alloy is cold worked (i.e., rolled into strips) and then annealed at temperatures between 400 F and 500 F for around 10 hours. Annealing at temperatures between 400 F and 500 F restores formability that is needed for cable armoring yet retains enough strength for the armored cable to meet tension tests. For example, tensile properties of an annealed strip are between 26.0 to 32.0 Kilopounds per Square Inch (KSI) Ultimate Tensile Strength (UTS) and a minimum elongation of 5.0% in 10″. The combination of softer armor due to the lower percentage of Magnesium (Mg) and the optimized annealing recipe leads to an increase in crush resistance of 25%. Table 1 summarizes tension test results for the UK alloy with different percentages of Magnesium (Mg).

TABLE 1
Tension test for the UK alloy with different percentages
of Magnesium (Mg) for a 16 ml strip.

| | | Annealing | Annealing | Crush | Tension | Tension to |
|---|---|---|---|---|---|---|
| Variation | Mg % | Temp | Time | Improvement | (150 lbs.) | failure |
| UK 22 500 | 2.2% | 500 | 10 hrs | 103% | PASS | 171.39 |
| UK 20 500 | 2.0% | 500 | 10 hrs | 101% | PASS | 162.53 |
| UK 20 450 | 2.0% | 450 | 10 hrs | 99% | PASS | 175.16 |
| UK 18 500 | 1.8% | 500 | 10 hrs | 126% | PASS | 155.48 |
| UK 18 450 | 1.8% | 450 | 10 hrs | 128% | PASS | 167.68 |

In example implementations, UK 22 500 is the UK alloy that includes 2.2% Magnesium (Mg) by weight and is annealed at 500 F. In addition, UK 20 500 is the UK alloy that includes 2.0% Magnesium (Mg) by weight and is annealed at 500 F. Moreover, UK 20 450 is the UK alloy that includes 2.0% Magnesium (Mg) by weight and is annealed at 450 F. Furthermore, UK 18 500 is the UK alloy that includes 1.8% Magnesium (Mg) by weight and is annealed at 500 F. In addition, UK 18 450 is the UK alloy that includes 1.8% Magnesium (Mg) by weight and is annealed at 450 F.

Table 2 summarizes crush test results for the UK alloy with different percentages of Magnesium (Mg).

TABLE 2
Crush test % improvement for the UK alloy with
different percentages of Magnesium (Mg).

| Sample # | UK 22 500 | UK 20 500 | UK 20 450 | UK 18 500 | UK 18 450 |
|---|---|---|---|---|---|
| 1 | 57% | 68% | 90% | 136% | 140% |
| 2 | 80% | 70% | 142% | 130% | 109% |
| 3 | 129% | 129% | 49% | 123% | 115% |
| 4 | 109% | 63% | 126% | 110% | 142% |
| 5 | 141% | 175% | 86% | 129% | 133% |
| Average | 103% | 101% | 99% | 126% | 128% |

Table 3 summarizes tension test results for the UK alloy with different percentages of Magnesium (Mg).

TABLE 3
Tension test for the UK alloy with different percentages of Magnesium (Mg).

| Sample # | UK 22 500 | UK 20 500 | UK 20 450 | UK 18 500 | UK 18 450 |
|---|---|---|---|---|---|
| 1 | 168.02 | 163.65 | 175.84 | 155.77 | 167.81 |
| 2 | 175.27 | 163.76 | 175.38 | 153.62 | 165.03 |
| 3 | 171.27 | 163.15 | 174.31 | 153.75 | 170.45 |
| 4 | 170.97 | 160.14 | 175.41 | 157.80 | 167.94 |
| 5 | 171.41 | 161.95 | 174.85 | 156.45 | 167.16 |
| Avg | 171.39 | 162.53 | 175.16 | 155.48 | 167.68 |
| Standard | 2.31 | 1.36 | 0.53 | 1.60 | 1.73 |
| Deviation | | | | | |

Table 4 summarizes tensile, elongation, and yield for UK 22 500 that includes 2.2% of Magnesium (Mg) and is annealed at 500F.

TABLE 4
Tensile, elongation, and yield test for UK 22 500.

| Sample # | UTS | Yield | E % |
|---|---|---|---|
| 1 | 28.5 | 17.6 | 13 |
| 2 | 28.6 | 17.9 | 13.8 |
| 3 | 28.8 | 17.5 | 14 |
| 4 | 28.3 | 17.2 | 14 |
| 5 | 28.8 | 17.5 | 14.8 |
| Average | 28.6 | 17.54 | 13.92 |

Table 5 summarizes tensile, elongation, and yield for UK 20 500 that includes 2.0% of Magnesium (Mg) and is annealed at 500F.

TABLE 5
Tensile, elongation, and yield test for UK 20 500.

| Sample # | UTS | Yield | E % |
|---|---|---|---|
| 1 | 27.8 | 17.5 | 12.6 |
| 2 | 27.4 | 17.4 | 11.4 |
| 3 | 27.7 | 17.7 | 12.8 |
| 4 | 27.5 | 17.6 | 13 |
| 5 | 27.7 | 17.4 | 13 |
| Average | 27.62 | 17.52 | 12.56 |

Table 6 summarizes tensile, elongation, and yield for UK 20 450 that includes 2.0% of Magnesium (Mg) and is annealed at 450F.

TABLE 6
Tensile, elongation, and yield test for UK 20 450.

| Sample # | UTS | Yield | E % |
|---|---|---|---|
| 1 | 32.6 | 28.3 | 7.8 |
| 2 | 32.6 | 28.3 | 7.8 |
| 3 | 33.2 | 28.5 | 8.8 |
| 4 | 32.4 | 28.4 | 9.4 |
| 5 | 33.1 | 28.4 | 8.5 |
| Average | 32.78 | 28.38 | 8.46 |

Table 7 summarizes tensile, elongation, and yield for UK 18 500 that includes 1.8% of Magnesium (Mg) and is annealed at 500F.

TABLE 6
Tensile, elongation, and yield test for UK 18 500.

| Sample # | UTS | Yield | E % |
|---|---|---|---|
| 1 | 26.7 | 16.7 | 14 |
| 2 | 26.6 | 17 | 13.6 |
| 3 | 26.4 | 16.4 | 14.2 |
| 4 | 26.5 | 16.9 | 12.2 |
| 5 | 26.5 | 17.1 | 14.2 |
| Average | 26.54 | 16.82 | 13.64 |

Table 8 summarizes tensile, elongation, and yield for UK 18 450 that includes 1.8% of Magnesium (Mg) and is annealed at 450F.

TABLE 8
Tensile, elongation, and yield test for UK 18 450.

| Sample # | UTS | Yield | E % |
|---|---|---|---|
| 1 | 31 | 26.3 | 9.4 |
| 2 | 31.2 | 26.4 | 10.8 |
| 3 | 31 | 26.5 | 9.2 |
| 4 | 31 | 26.6 | 9.8 |
| 5 | 31 | 26.6 | 9 |
| Average | 31.04 | 26.48 | 9.64 |

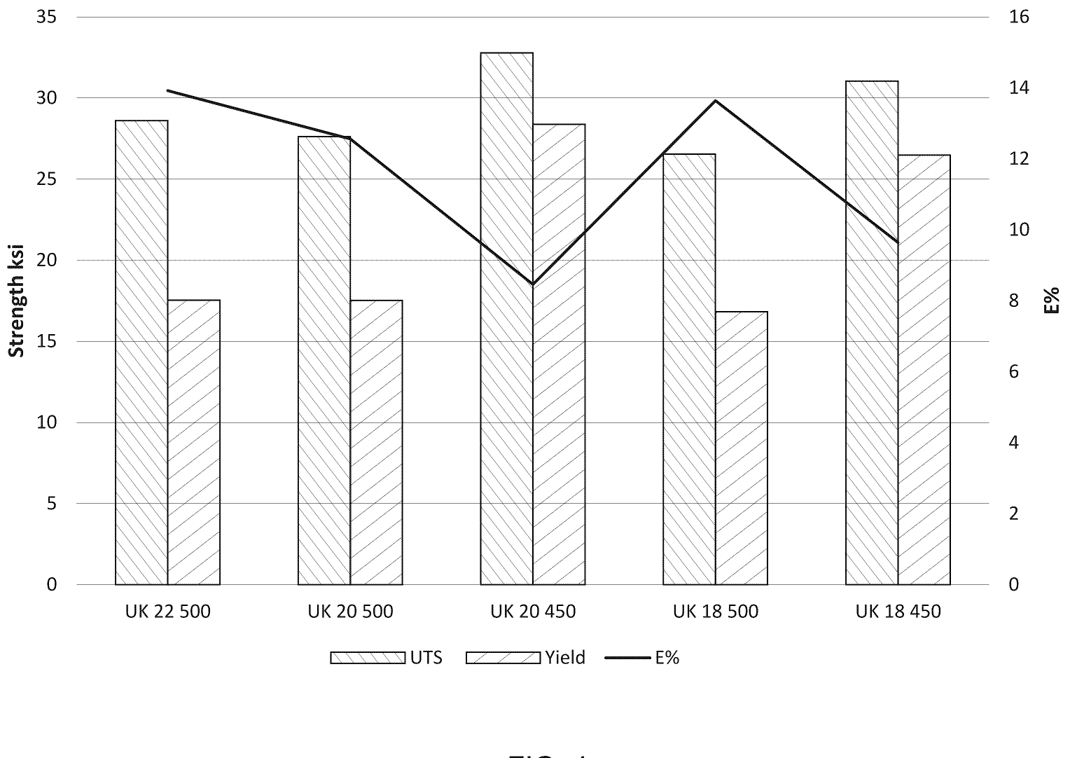

FIG. 4 is a graph illustrating Tensile, Elongation and yield of the UK alloy with different percentages of Magnesium (Mg). Thus, the UK alloy uses less quantities of magnesium compared to aluminum alloy 5154 that includes 3.2% Magnesium (Mg). With the reduction in Magnesium (Mg), manufacturing of the disclosed UK alloy has less dross generation, easier mixing of loads and more consistent quality. Additionally with reduced levels of Magnesium (Mg) there is less chance for intermetallic segregation during solidification. This translates into fewer edge cracks in the metal strip and ultimately less breakouts during the armoring stage. In addition, finished goods total life cycle carbon emissions are also reduced. For example, Magnesium (Mg) has a higher carbon footprint than aluminum and using a lower annealing temperature reduces energy consumption.

The UK alloy is softer than the traditional 5154 alloy. However, the surprising part is the softer armor is beneficial to the finished cable in crush test performance. 10%-20% increase is seen in crush performance when using the softer armor made of the UK alloy. The crush test is another requirement in UL1569 where the cable is crushed between a flat plate and round rod until it shorts out. The cable must withstand 1000 lbs averaged over 10 crushes to pass the test.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. An aluminum alloy material having an alloy composition comprising by mass %, magnesium in an amount of 1.8%-2.5%, iron in an amount of 0.10%-0.90%, and aluminum in an amount of 98.1%-95%.

2. The aluminum alloy material of claim 1, wherein the alloy composition comprising by mass %, magnesium in the amount of 1.8%, iron in the amount of 0.10%-0.90%, and aluminum in an amount of 98.1%-95%.

3. The aluminum alloy material of claim 1, wherein the alloy composition comprising by mass %, magnesium in the amount of 2.0%, iron in the amount of 0.10%-0.90%, and aluminum in an amount of 97.9%-95%.

4. The aluminum alloy material of claim 1, wherein the alloy composition comprising by mass %, magnesium in the amount of 2.2%, iron in the amount of 0.10%-0.90%, and aluminum in an amount of 97.7%-95%.

5. The aluminum alloy material of claim 1, wherein the aluminum is recycled from aluminum products.

6. The aluminum alloy material of claim 1, wherein the magnesium is added to the aluminum alloy material from recycled aluminum products.

7. A method of manufacturing an aluminum alloy material having an alloy composition comprising by mass %, magnesium in an amount of 1.8%-2.5%, iron in an amount of 0.10%-0.90%, and aluminum in an amount of 98.1%-95%, the method comprising:
mixing loads of aluminum;
heating the loads of aluminum to their melting point;
casting molten loads and rolling rods from cast;
cold rolling the rods to strips;
annealing the strips; and
casting the annealed strips and rolling rods from cast.

8. The method of claim 7, wherein heating the loads of aluminum to their melting point comprising heating the loads to a temperature between 1400-1500 degrees Fahrenheit.

9. The method of claim 7, wherein heating the loads of aluminum to their melting point comprising further comprises determining whether the molten loads include by mass 1.8%-2.5% of Magnesium and 0.10%-0.90% of iron.

10. The method of claim 9, wherein in response to determining that the molten loads do not include by mass 1.8%-2.5% of Magnesium and 0.10%-0.90% of iron adding more loads to achieve by mass 1.8%-2.5% of Magnesium and 0.10%-0.90% of iron.

11. The method of claim 10, wherein adding more loads comprises adding more iron or magnesium to increase percentages of iron and magnesium.

12. The method of claim 10, wherein adding more loads comprises adding more aluminum to decrease percentages of iron and magnesium.

13. The method of claim 7, wherein annealing the strips comprises:
heating the strips to a temperature between 400 F and 500 F for a predetermined time; and
allowing the strips to cool slowly.

14. The method of claim 13, wherein the predetermined time depends on an amount or weight of the strips and a size of an annealing container.

15. An armored cable comprising:
at least one electrical conductor;
an armor sheath enclosing the at least one electrical conductor, wherein the armor sheath comprises:
an elongated strip formed in continuous helical interlocked convolutions; and
an aluminum alloy material having an alloy composition comprising by mass %, magnesium in an amount of 1.8%-2.5%, iron in an amount of 0.10%-0.90, and aluminum in an amount of 98.1%-95%.

16. The armored cable of claim 15, wherein the alloy composition comprising by mass %, magnesium in the amount of 1.8%, iron in the amount of 0.10%-0.90%, and aluminum in an amount of 98.1%-95%.

17. The armored cable of claim 15, wherein the alloy composition comprising by mass %, magnesium in the amount of 2.0%, iron in the amount of 0.10%-0.90%, and aluminum in an amount of 97.9%-95%.

18. The armored cable of claim 15, wherein the alloy composition comprising by mass %, magnesium in the amount of 2.2%, iron in the amount of 0.10%-0.90%, and aluminum in an amount of 97.7%-95%.

19. The armored cable of claim 15, wherein the aluminum is recycled from aluminum products.

20. The armored cable of claim 15, wherein the magnesium is added to the aluminum alloy material from recycled aluminum products.
